(19) United States
(12) Patent Application Publication
(10) Pub. No.: US 2011/0254507 A1
(43) Pub. Date: Oct. 20, 2011

(54) CHARGING DEVICE AND CHARGING METHOD

(76) Inventor: Chia Han CHAN, Taipei County (TW)

(21) Appl. No.: 12/879,590

(22) Filed: Sep. 10, 2010

(30) Foreign Application Priority Data
Apr. 14, 2010 (TW) 099111545

(51) Int. Cl. H02J 7/00

(52) U.S. Cl. 320/116

(57) ABSTRACT

A charging device for charging a first battery cell and a second battery cell comprises a node, a control circuit, a charging circuit and a current-dividing unit. The control circuit is coupled to the charging circuit, the current-dividing unit, and the first and second battery cells. The control circuit controls the charging circuit to provide a first charge current or a second current for the node which couples to the first battery cell and the current-dividing unit and controls the state of the current-dividing unit. The current-dividing unit is set to share the current flowing into the node and acts as an open circuit in a first state and a resistor of finite resistance in a second state.

### BACKGROUND OF THE INVENTION

1. Field of the Invention

The present invention relates to a charging device and a charging method, especially to a charging device and a charging method with charge balance function.

2. Description of Related Art

Rechargeable batteries have the advantages of economic benefits and convenience. FIG. 1 is a diagram showing a well-known charging circuit connecting with a rechargeable battery. As shown in FIG. 1, the rechargeable battery 10 includes a plurality of battery cells 11 connected to each other in series. The charging circuit 21 connects to the two ends of the rechargeable battery 10, so as to charge each of the battery cells 11 of the rechargeable battery 10. However, when applying the above-mentioned charging system to a high-power rechargeable battery with a great amount of battery cells connected together in series and/or parallel such as a rechargeable battery of an electric vehicle, a charge imbalance often occurs. As a result, some battery cells of the rechargeable battery couldn't be fully charged or some battery cells could be over charged such that inefficient and/or safety issues are raised.

In order to solve the problem of charge imbalance, a protection IC is set between the rechargeable battery 10 and the charging circuit 21, which is used to balance the charge states of the battery cells 11. However, the charging method carried out by the existing protection IC can't efficiently achieve the purpose of charge balance and thereby a more efficient charging method is necessary.

### SUMMARY OF THE INVENTION

The present invention provides a charging device and a charging method capable of achieving charge balance of battery cells. Besides, the present invention provides a charging device and a charging method for finely tuning the charge states of battery cells.

According to an embodiment of the present invention, a charging device is provided to charge a plurality of battery cells. The plurality of battery cells comprises a first battery cell and a second battery cell, each of them having a first electrode and a second electrode. The second electrode of the first battery cell couples to the first electrode of the second battery cell such that the first and second battery cells connect to each other in series. The charging device comprises a node, a charging circuit, a current-dividing unit and a control circuit. The node couples to the first electrode of the first battery cell while the charging circuit couples to the node for providing a first charge current or a second charge current for it, wherein the first charge current is larger than the second charge current. The current-dividing unit couples to the node and functions as an open circuit under a first state and a resistor with finite resistance under a second state. The control circuit, which couples to the charging circuit, the current-dividing unit, the first battery cell and the second battery cell, generates a voltage detection result by detecting the voltages of the first and second battery cells and accordingly controls the state of the current-dividing unit and the current of the charging circuit.

The control circuit comprises a front-end circuit and a back-end circuit. The front-end circuit couples to the first battery cell, the second battery cell and the current-dividing unit, and generates the voltage detection result by detecting the voltages of the first and second battery cells respectively. The back-end circuit couples to the front-end circuit and the charging circuit, receives the voltage detection result from the front-end circuit and controls the front-end circuit change the state of the current-dividing unit from the first state to the second state if this voltage detection result indicates an unbalanced state. The back-end circuit further controls the charging circuit provide the second charge current instead of the first charge current if the voltage detection result indicates an unbalanced fine-tune state.

In an embodiment of this invention, the current-dividing unit includes a switch component and a resistor. The switch component enters an on state or an off state according to the control of the front-end circuit. When the switch component enters the off state, the current-dividing unit is under the first state and blocks the charge current from the charging circuit. When the switch component enters the on state, the current-dividing unit is under the second state and divides the charge current; meanwhile, a partial charge current of the charge current flows to the resistor via the switch component while the other partial charge current of the charge current keeps going to the first battery cell.

In an embodiment of this invention, the current-dividing unit comprises a first switch component and an energy-storage unit. The first switch component, the energy-storage unit and the first battery cell constitute a loop. When the first switch component enters an off state according to the control of the front-end circuit, the current-dividing unit is under the first state and blocks the charge current. When the first switch component enters an on state according to the control of the aforementioned front-end circuit, the current-dividing unit is under the second state and divides the charge current from the charging circuit; meanwhile, a partial charge current of the charge current flows through the energy-storage unit which thereby stores the energy of the partial charge current. Once the first switch component changes its state from the second state to the first state, the energy-storage unit will couple to the two ends of the second battery cell and release its storage energy to charge it.

In this embodiment, the current-dividing unit further comprises a second switch component which enters an on state or an off state according to the control of the aforementioned front-end circuit. The second switch component, the energy-storage unit and the second battery cell constitute another loop. When the first switch component enters the on state, the second switch component stays the off state; meanwhile the energy-storage unit stores the energy of the partial charge current. When the first switch component enters the off state, the second switch component enters the on state; meanwhile, the energy-storage unit releases its storage energy to charge the second battery cell.

In this embodiment, the energy-storage unit includes an inductor.

In an embodiment of the present invention, the aforementioned back-end circuit comprises a setting unit provided for a user to set the amounts of the first and second currents. In another embodiment, the back-end circuit comprises a learning unit for collecting historical data about the usage information of the charging device and determining the amounts of the first and second charge current in accordance with the historical data.

According to an embodiment of the present invention, a charging method for charging a plurality of battery cells is disclosed. The plurality of battery cells comprises a first battery cell and a second battery cell. Each of the first and second battery cells includes a first electrode and a second electrode, wherein the second electrode of the first battery cell couples to the first electrode of the second battery cell such that the first and second battery cells couple to each other in series. The first electrode of the first battery cell further couples to a node which couples to a current-dividing unit and a charging circuit. The charging method comprises the following steps: utilizing the charging circuit to provide a first charge current for the node; detecting the voltages of the first and second battery cells to generate a voltage detection result; changing the state of the current-dividing unit from a first state to a second state if the voltage detection result indicates an unbalanced state; providing a second charge current instead of the first charge current for the node if the voltage detection result indicates an unbalanced fine-tune state, wherein the first charge current is larger than the second charge current.

In the above-mentioned embodiment, the current-dividing unit may comprise an energy storage unit. When the current-dividing unit is under the second state, a partial charge current of the first charge current flows through the energy-storage unit and allows it storing the energy of the partial charge current. Once the current-dividing returns to the first state from the second state, the energy-storage unit will couple to the second battery cell and then charge it.

In an embodiment of this invention, the charging method further comprises a step of collecting historical data about the usage information of the charging circuit and determining the amounts of the first and second charge currents according to the historical data.

According to an embodiment of the present invention, a charging device is provided for charging a plurality of battery cells. The plurality of battery cells comprises a first battery cell and a second battery cell, each of which comprises a first electrode and a second electrode. The second electrode of the first battery cell couples to the first electrode of the second battery cell such that the first and second battery cells couple to each other in series. The charging device includes a node, a charging circuit, a current-dividing unit and a control circuit. The node couples to the first electrode of the first battery cell while the charging circuit couples to the node and provides a charge current for it. The current-dividing unit couples to the node, includes an energy-storage unit and has first impedance under a first state and second impedance under a second state, wherein the first impedance is higher than the second impedance. The control circuit couples to the charging circuit, the current-dividing unit, the first battery cell and the second battery cell, so as to control the state of the current-dividing unit and the current amount of the charge current. When the state of the current-dividing unit enters the second state, the current-dividing unit shares the charge current such that a partial charge current of the charge current flows through the energy-storage unit which thereby stores the energy of it. When the current-dividing unit changes its state from the second state to the first state, it couples to the second battery cell and thereby the energy-storage unit can charge the second battery cell with its stored energy.

As described above, when a first battery cell among a plurality of battery cells reaching an unbalanced state is detected, the present invention uses an total charge current to charge the battery cells without charge imbalance and uses a part of the total charge current to charge the first battery cell under the unbalanced state. Hence, the voltage differential between the battery cells without charge imbalance and the first battery cell under the unbalanced state will be reduced. Besides, when the first battery cell reaching an unbalanced fine-tune state is detected, the present invention provides a balanced fine-tune current less than the total charge current to further reduce said voltage difference. Accordingly, each of the battery cells can be fully charged.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a well-known charging circuit connecting with a rechargeable battery.

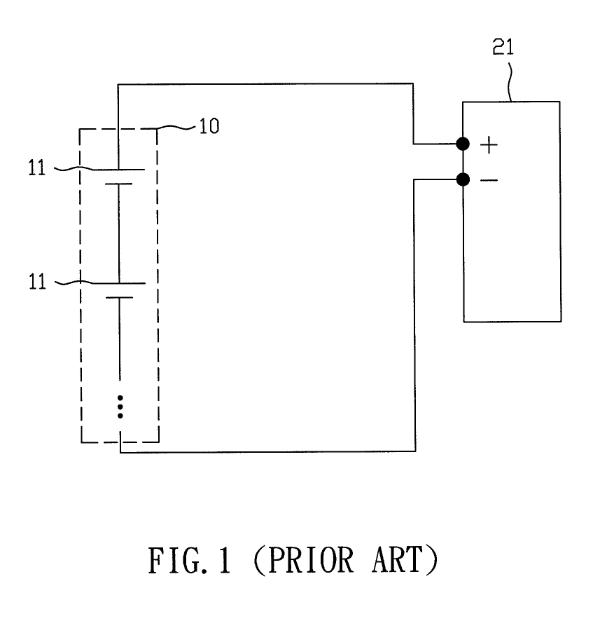

FIG. 2 is a diagram showing a charging device coupling to a rechargeable battery according to an embodiment of the present invention.

FIG. 3A is a circuitry diagram showing a part of the connection relation between the current-dividing units and the battery cells according to an embodiment of the present invention.

FIG. 3B is a circuitry diagram showing a part of the connection relation between the current-dividing units and the battery cells according to another embodiment of the present invention.

FIG. 4 is a block diagram illustrating the back-end circuit according to an embodiment of the present invention.

FIG. 5A is a flow chart of the charging method according to an embodiment of the present invention.

FIG. 5B is a flow chart showing the subordinate steps of the step S06 of FIG. 5A.

### DETAILED DESCRIPTION OF THE PREFERRED EMBODIMENTS

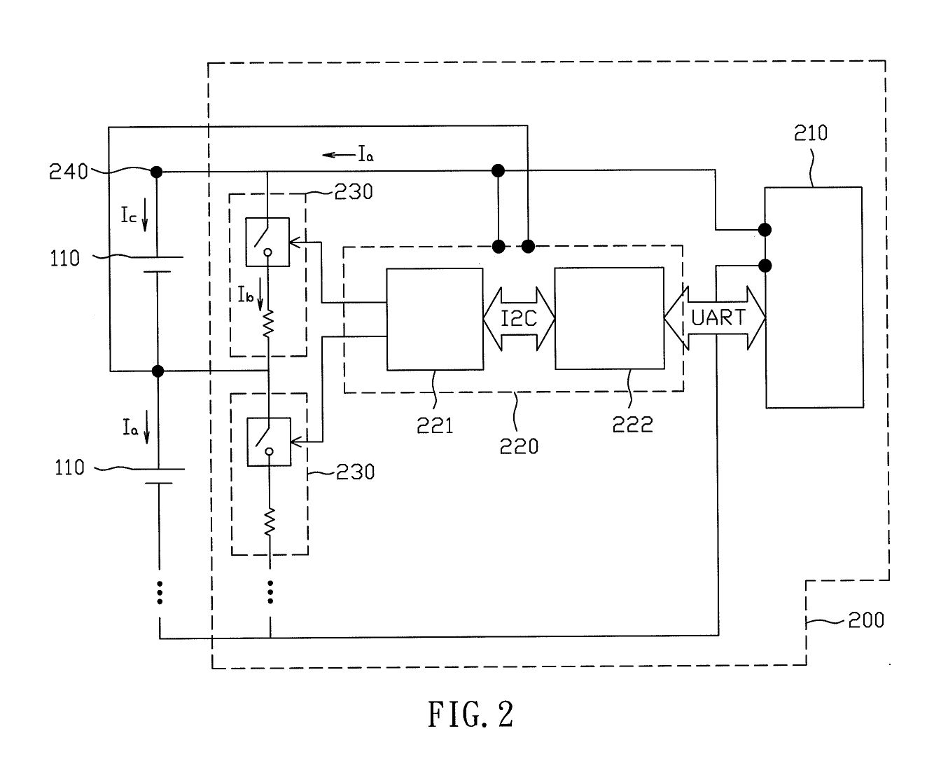

FIG. 2 is a diagram showing a charging device coupling to a rechargeable battery according to an embodiment of the present invention. As shown in FIG. 2, the charging device 200 connects to a battery to charge it. The battery includes a plurality of battery cells 110 which connect to each other in series and thereby form a plurality of connection nodes. The charging device 200 includes a node 240, a plurality of the current-dividing units 230, a control circuit 220 and a charging circuit 210. The node 240 couples to one of the battery cells 110 of the battery while the charging circuit 210 couples to the node 240 to provide it a total charge current Ia. The total charge current Ia may be reduced to a balance fine-tune current Ia1 which will be described in detail later. The plurality of current-dividing units 230 correspond to the battery cells 110 respectively. Each current-dividing unit 230 has first impedance under a first state and second impedance less than the first impedance under a second state, and is used for sharing the charge current Ia from the charging circuit 210 which is consequently divided into a partial charge current Ib flowing through the current-dividing unit 230 and a partial charge current Ic flowing through the battery cell 110. More specifically, each of the current-dividing units 230 functions as an open circuit with infinite impedance under the first state and a resistor with finite impedance. In this embodiment, each current-dividing unit 230 connects to its corresponding battery cell 110 in parallel. Besides, the control circuit 220 is used for detecting the voltages of the battery cells 110. When an unbalanced state or an unbalanced fine-tune state of the battery cells 110 is detected, the current-dividing units 230 start sharing the charge current Ia from the charging circuit 210; otherwise, it blocks the charge current Ia. The control circuit 220 communicates with the charging circuit 210 through a universal asynchronous receiver/transmitter (hereafter “UART”) unit which couples to the charging circuit 210, and utilizes a control signal to control the amount of the charge current Ia. An example of the control signal is a pulse width modulation signal generated by the UART unit.

In this embodiment, the control circuit 220 comprises a front-end circuit 221 and a back-end circuit 222, wherein the front-end circuit 221 includes a protection circuit while the back-end circuit 222 includes a computing unit or a microprocessor. The back-end circuit 222 couples to the front-end circuit 221 through an I²C bus interface which is well-known in this field; so they can communicate with each other. The front-end circuit 221 detects the voltages of the battery cells 110 and provides a voltage detection result for the back-end circuit 222. When the back-end circuit 222 determines an unbalanced state existing between the battery cells 110 according to the voltage detection result, it commands the front-end circuit 221 to issue a switch signal Sw to the plurality of current-dividing units 230 through the I²C bus interface and thus controls the plurality of current-dividing units 230 sharing the charge current Ia from the charging circuit 210.

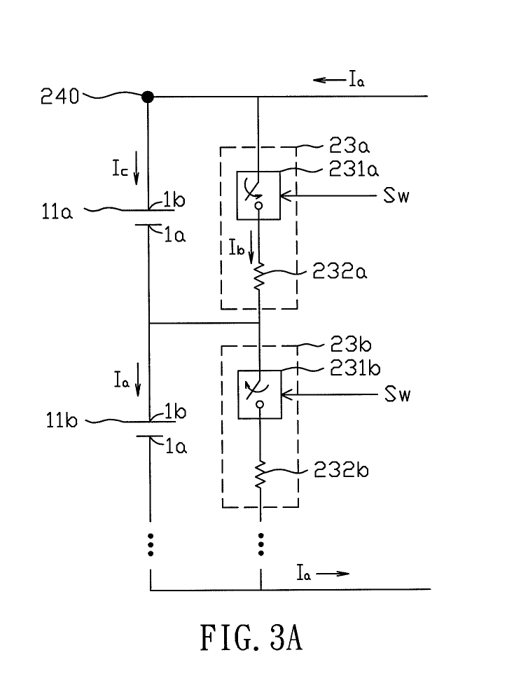

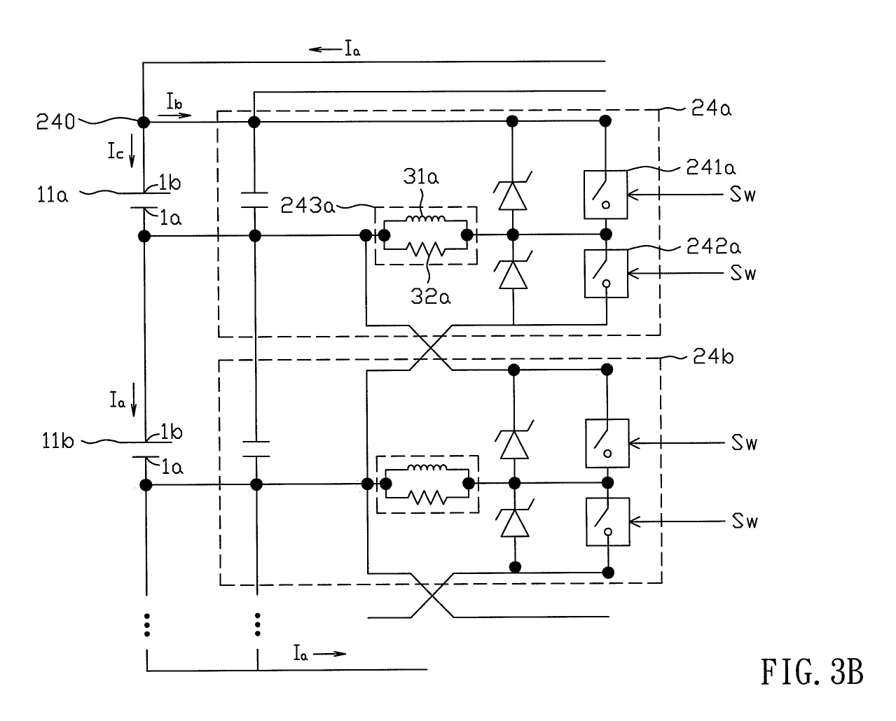

FIG. 3A is a circuitry diagram showing a part of the connection relation between the current-dividing units and the battery cells according to an embodiment of the present invention. As shown in FIG. 3A, the node 240 couples to a first electrode 1b of the batter cells 110. The battery cells comprise a battery cell 11a and a battery cell 11b, each of which includes a first electrode 1b and a second electrode 1a. The second electrode 1a of the battery cell 11a couples to the first electrode 1b of the battery cell 11b such that the battery cells 11a and 11b connect together in series; the battery cell 11a connects to its corresponding current-dividing unit 23a in parallel and the battery cell 11b also connects to its corresponding current-dividing unit 23b in parallel. Besides, the current-dividing unit 23a comprises a switch component 231a and a resistor 232a; similarly, the current-dividing unit 23b comprises a switch component 231b and a resistor 232b. Since the current-dividing units 23a and 23b are substantially the same, only the current-dividing unit 23a will be illustrated in the following. Please refer to the FIG. 3A, when the switch component 231a enters an off state, the current-dividing unit 23a is under a first state and acts as an open circuit to block the charge current Ia. When the switch component 231a enters an on state, the current-dividing unit 23a is under a second state and functions with the resistor 232a. When executing a charging operation, under an initial stage, the switch components 231a and 231b are preset to be under the off state; meanwhile, the charging circuit 210 generates an total charge current Ia.

When the back-end circuit 222 determines that the battery cell 11a has the problem of charge imbalance, it controls the front-end circuit 221 to issue a switch signal Sw to make the switch component 231a of the current-dividing unit 23a enter the on state. Consequently, the current-dividing unit 23a enters the second state and starts sharing the total charge current Ia from the charging circuit 210. Meanwhile, the current flowing through the resistor 232a of the current-dividing unit 23a is a partial charge current Ib and the current flowing through the battery cell 11a is a partial charge current Ic, i.e. the rest of the total charge current Ia. Because the state of the switch component 231b is still under the off state, the current passing through the battery cell 11b equals to sum of the currents Ib and Ic, i.e. the initial charging Ia, that is to say, no substantial current flowing through the resistor 232b of the current-dividing unit 23b. To explain more in detail, assuming that the resistance of the resistor 232a is R1, the internal resistance of the battery cell 11a is RH and the voltage of the battery cell 11a is VH, the following equations can be derived according to Kirchhoff's circuit laws: Ia=Ic+Ib; Ib×R1=VH; Ic=Ia−Ib; and Ib=VH/R1, wherein Ib is higher than zero, Ic is less than Ia, and the ratio of the partial charge current Ic to the total charge current Ia is Ic/Ia=(Ia−Ib)/Ia=1−Ib/Ia. Under the situation that the first battery cell 11a has been charged more than the second battery cell 11b and reached the unbalanced state, the total charge current Ia is used to charge the battery cell 11b while only a part of the total charge current Ia, i.e. the partial charge current Ic, is used to charge the battery cell 11a. Accordingly, the voltage difference between the battery cells 11a and 11b, which are assumed to be the same in this embodiment, is reduced. In other words, the difference of remaining power between the battery cells 11a and 11b is decreased. Please note that a person of ordinary skill in the art will appreciate how to set the unbalanced state. For example, the unbalanced state could be reached if the voltage of the battery cell 11a is higher than a first preset over-charge value (e.g. 3.4V for a LeFeO4 charging unit) and/or the voltage difference between the battery cell 11a and any of the other battery cells 110 is higher than a preset balance value (e.g. 10 mv).

Besides, if the back-end circuit 222 determines that the voltage of the battery cell 11a further reaches an unbalanced fine-tune state, it will control the charging circuit 210 to reduce its outputted current from the total charge current Ia to a balance fine-tune current Ia1 (not depicted in the figures). Under this condition, the current flowing through the battery cell 11a is a part of the balance fine-tune current Ia1, i.e. a partial charge current Ic1 (not depicted in the figures), the current shared by the current division unit 23a is a partial current Ib1 (not depicted in the figures), the current flowing through the battery cell 11b is the balance fine-tune current Ia1, and the ratio of the current Ic1 to the current Ia1 is Ic1/Ia1=(Ia1−Ib1)/Ia1=1−Ib1/Ia1. In accordance with the Kirchhoff's circuit laws, the equation Ib=Ib1=VH/R1 is realized. Since the balance fine-tune current Ia1 is less than the total charge current 1a and the current Ib equals to the current Ib1, the ratio Ic1/Ia1=[1−(Ib1/Ia1)] is thereby less than the ratio Ic/Ia=[1−(Ib/Ia)]. As a result, the current difference between the currents for respectively charging the battery cells 11a and 11b under the unbalanced fine-tune state is enhanced, which can further reduce the voltage difference between the battery cells 11a and 11b, that is to say, reducing the difference of remaining power between them. Please note that a person of ordinary skill in the art will appreciate how to set an unbalanced fine-tune state. For example, the unbalanced fine-tune state could be reached when the voltage of the battery cell 11a is higher than a second preset over-charge value (e.g. 3.5V for a LeFeO4 charging unit, which is higher than the aforementioned first preset over-charge value) and/or the voltage difference between the battery cell 11a and any of the other battery cells 110 is higher than a preset balance value (e.g. 10 mv).

Moreover, when the back-end circuit 222 determines that a cease-charging condition is satisfied according to the voltage detection result from the front-end circuit, it has the charging circuit 201 stop providing current for the battery cells 110, i.e. stopping charging the battery cells 110. Please note that a person of ordinary skill in the art will appreciate how to set the cease-charging condition according to different applications and/or usage environments. For example, the cease-charging condition is satisfied when the voltage difference between any two battery cells 110 is less than a preset balance value (e.g. 10 mv).

FIG. 3B is a circuitry diagram showing a part of the connection relation between the current-dividing units and the battery cells of another embodiment according to the present invention. As shown in FIG. 3B, a battery cell 11a connects with a battery cell 11b in series, the battery cell 11a connects to a current-dividing unit 24a in parallel and the battery cell 11b connects to another current-dividing unit 24b in parallel. In this embodiment, every current-dividing unit substantially functions in the same way and thus only the current-dividing unit 24a will be explained in the following description. Please refer to FIG. 3B. The current-dividing unit 24a comprises an energy-storage unit 243a. When a charge imbalance occurs, the current-dividing unit 24a enters a second state and shares the charge current Ia from the charging circuit 210 such that a partial charge current 1b flows to the current-dividing unit 24a while the other partial charge current Ic flows to the battery cell 11a. Therefore, the partial charge current Ib flows through the energy-storage unit 243a of the current-dividing unit 24a which thereby stores the power of the partial charge current Ib. When the charge imbalance is terminated, the current-dividing unit 24a enters a first state from the second state and functions as an open circuit which thereby shares nothing of the charge current Ia; meanwhile, the current-dividing unit 24a couples to the battery cell 11b, so as to allow the energy-storage unit 243a releasing its storage power to charge the battery cell 11b.

The following will go into detail on the present embodiment. The current-dividing unit 24a comprises a first switch component 241a, a second switch component 242a and an energy-storage unit 243a. The first switch component 241a, the energy-storage unit 243a and the battery cell 11a constitute a loop. To be more specific, the battery cell 11a has a first electrode 1b coupling to a first end of the first switch component 241a, the first switch component 241a has a second end coupling to a first end of the energy-storage unit 243a, and the energy-storage unit 243a has a second end coupling to a second electrode of the battery cell 11a. Besides, the battery cell 11b has a first electrode 1b coupling to a first end of the energy-storage unit 243a, the energy-storage unit 243a has a second end coupling to a first end of the first switch component 242a, and the first switch component 242a has a second end coupling to a second electrode 1a of the battery cell 11b. Furthermore, the first electrode 1b of the battery cell 11b couples to the second electrode 1a of the battery cell 11a. In this embodiment, the energy-storage unit 243a comprises an inductor 31a and a resistor 32a which are connected together in parallel.

When executing the charging operation, under an initial stage, the switch components 241a and 242a of the current-dividing unit 24a are preset to be under the off state; meanwhile, the charging circuit 210 generates an total charge current Ia.

When the back-end circuit 222 determines that the battery cell 11a has been charged more than any of the other battery cells and reached an unbalanced state based on the voltage detection result of the front-end circuit 221, it controls the front-end circuit 221 issuing a switch signal Sw which allows the first switch component 241a of the current-dividing unit 24a entering an on state; meanwhile, the second switch component 242a remains in the off state and the current-dividing unit 24a shares the total charge current Ia from the charging circuit 210 in a predetermined current-division period. At this time, the current flowing through the battery cell 11a is a partial charge current Ic and the current passing through the current-dividing unit 24a is a partial charge current Ib. Since all the switch components of the current-dividing unit 24b remain the off state, the current-dividing unit 24b is therefore under a first state. Consequently, the current flowing through the battery cell 11b equals to the total charge current Ia, that is to say, no substantial current being shared by the current-dividing unit 24b. According to Kirchhoff's circuit laws, the equation Ic=Ia−Ib is realized, wherein the partial charge current Ib is less than the total current Ia and the ratio of the partial charge current Ic to the total charge current Ia is Ic/Ia=(Ia−Ib)/Ia=1−Ib/Ia. Therefore, when detecting imbalance (e.g. the voltage of the battery cell 11a being higher than the voltage of the battery cell 11b to a certain degree), the total charge current Ia is used to charge the battery cell 11b while the partial charge current Ic is used to charge the battery cell 11a. As a result, the voltage difference between the battery cells 11a and 11b is reduced, that is to say, the difference of remaining power between the battery cells 11a and 11b being decreased. Furthermore, the partial charge current Ib flows through the energy-storage unit 243a which thereby stores the electric energy of the current Ib. More specifically, the energy-storage unit 243a includes an inductor 31a which stores the energy of the partial charge current Ib within the predetermined current-division period and releases its storage energy if the partial charge current Ib diminishes. As the predetermined current-division period went by, the front-end circuit 221 controls the first switch component 241a entering the off state. Consequently, the current-dividing unit 24a returns to the first state to act as an open circuit and the partial charge current Ib passing through it becomes zero. In other words, the current-dividing unit 24a stops sharing the total charge current Ia from the charging circuit 210. On the other hand, the front-end circuit 221 controls the second switch component 242a entering the on state and thereby has the current-dividing unit 24a couple to the battery cell 11b. The inductor 31a now connects between the two ends of the battery cell 11b. Since the current Ib keeps decreasing or has decreased to zero, the inductor 31a is induced to release its energy to charge the battery cell 11b. Hence, the charging device of this embodiment not only solves the problem of charge imbalance but also gains the benefit of power consumption.

Additionally, if the back-end circuit 222 determines that the detection result of the front-end circuit indicates an unbalanced fine-tune state, it controls the charging circuit 210 reducing its outputted current from the total charge current Ia to a balanced fine-tune current Ia1 (not depicted in the figures). Now, the charge current for charging the battery cell 11a is Ic1 (not depicted in the figures), the division current shared by the current division unit 24a is Ib1 (not depicted in the figures), the charge current for charging the battery cell 11b is Ia1, and the ratio of the current Ic1 to the current Ia1 is Ic1/Ia1=(Ia1−Ib1)/Ia1=1−Ib1/Ia1. Since the ratio Ic1/Ia1 is smaller than the ratio Ic/Ia as explained before, the charging rate difference between the battery cells 11a and 11b is further improved through this more precise manner.

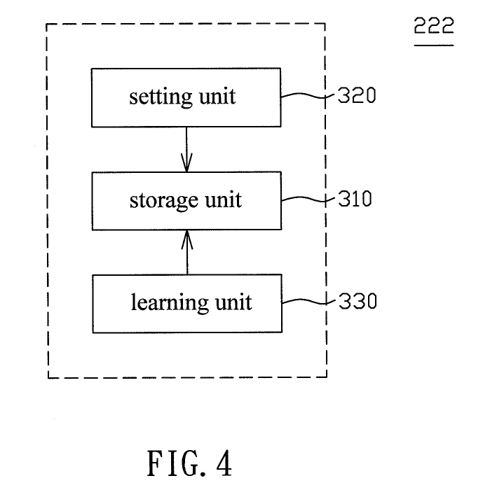

FIG. 4 is a block diagram illustrating the back-end circuit according to an embodiment of the present invention. As illustrated in FIG. 4, the back-end circuit 222 comprises a storage unit 310 such as a non-volatile memory. The storage unit 310 stores the default values of the total charge current Ia and the balance fine-tune current Ia1. The back-end circuit may further comprise a setting unit 320 which allows a user setting the value of the total charge current Ia and/or the value of the balance fine-tune current Ia1 which will be kept in the storage unit 310 after finishing setting. Additionally, the back-end circuit may comprise a learning unit 330 which collects historical data about how a user utilizes the charging device 200 to charge a battery, i.e. the usage information of the charging device 200, and thereby determines auto-adjustment values of the total charge current Ia and the balance fine-tune current Ia1 which will be stored in the storage unit 310. For instance, the learning unit 330 may collect data such as the duration of charging a battery each time, the time for a battery cell of the battery entering the unbalanced state and the time for a battery cell of the battery entering the unbalanced fine-tune state, and adaptively adjust the values of the total charge current Ia and the balance fine-tune current Ia1 according the collected data. More specifically, each kind of the collected data may be multiplied by its own weighting value and all of them will be normalized afterward to generate a factor. This factor is then multiplied by the total charge current Ia and the balance fine-tune current Ia1 to fulfill the adaptive adjustment. Please note that based on the disclosure of this invention, a person of ordinary skill in the art will appreciate how to set the weighting value for each collected parameter in accordance with real implementations.

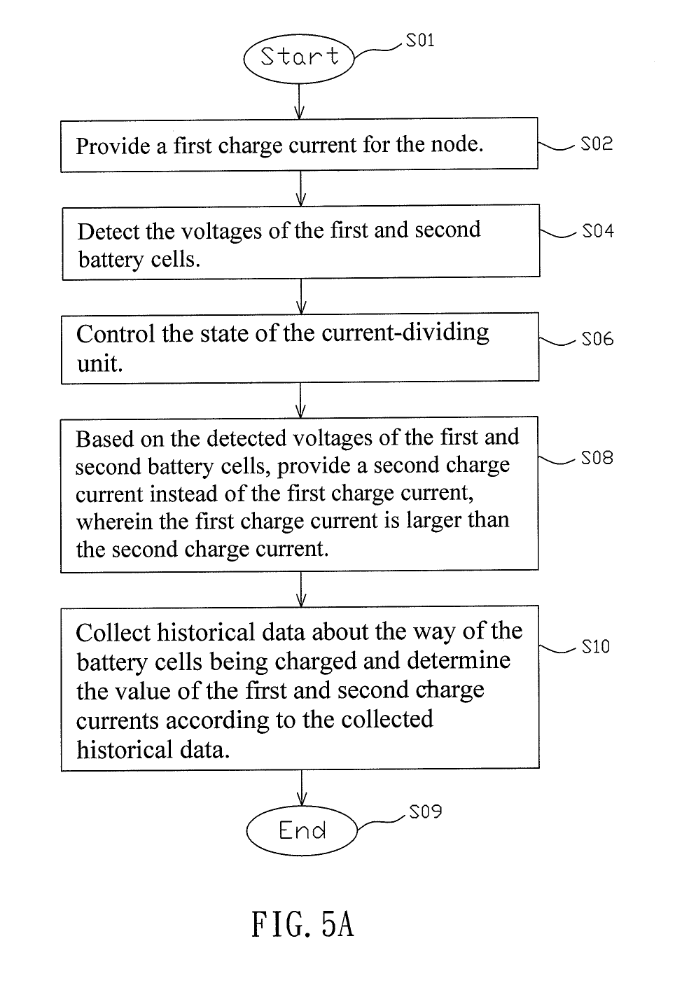

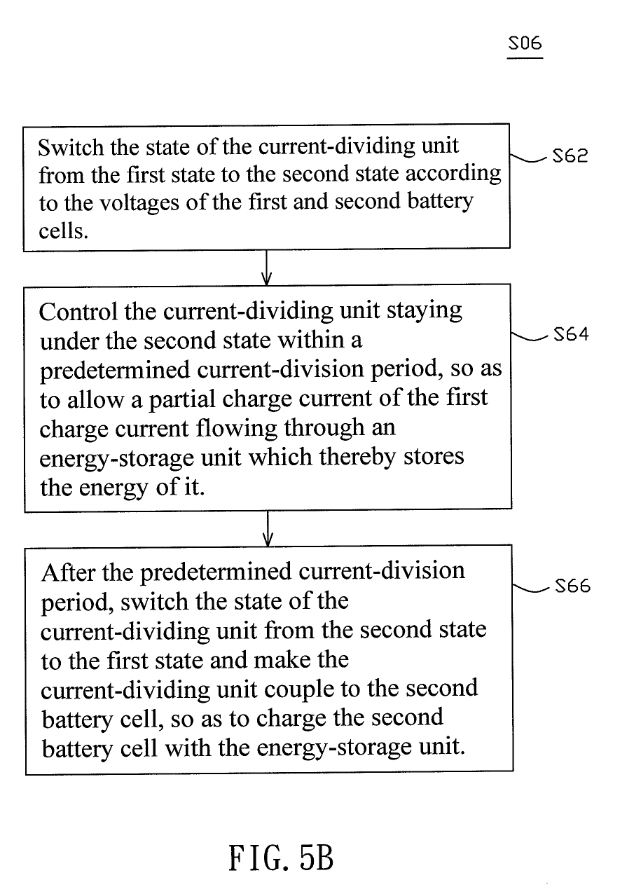

FIG. 5A is a flow chart of the charging method according to an embodiment of the present invention. The charging method is used for charging a plurality of battery cells which comprises a first battery cell and a second battery cell. Each of the first and second battery cells includes a first electrode and a second electrode. The second electrode of the first battery cell couples to the first electrode of the second battery cell such that the first and second battery cells connect to each other in series. Furthermore, the first electrode of the first battery cell couples to a node which also couples to a current-dividing unit. Please refer to FIG. 5A, the charging method comprises the following steps.

Step S02: Provide a first charge current for the node.

Step S04: Detect the voltages of the first and second battery cells.

Step S06: Control the state of the current-dividing unit.

Step S08: Based on the detected voltages of the first and second battery cells, provide a second charge current instead of the first charge current, wherein the first charge current is larger than the second charge current. In this embodiment, when reaching an unbalanced fine-tune state of the first battery cell, the second charge current is provided to replace the first charge current. The unbalanced fine-tune state may indicate that the voltage of the first battery cell is higher than a preset over-charge value and the voltage difference between the first and second battery cells is higher than a preset balance value.

Step S10: Collect historical data about the way of the battery cells being charged and determine the value of the first and second charge currents according to the collected historical data.

FIG. 5B is a flow chart showing the subordinate steps of the step S06 of FIG. 5A. As shown in FIG. 5B, the step S06 comprises the following steps.

Step S62: Switch the state of the current-dividing unit from the first state to the second state according to the voltages of the first and second battery cells. The current-dividing unit has first impedance (e.g. infinite impedance of an open circuit) under a first state and second impedance (e.g. finite impedance of a resistor) under a second state, in which the second impedance is less than the first impedance.

Step S64: Control the current-dividing unit staying under the second state within a predetermined current-division period, so as to allow a partial charge current of the first charge current flowing through an energy-storage unit which thereby stores the energy of it.

Step S66: After the predetermined current-division period, switch the state of the current-dividing unit from the second state to the first state and make the current-dividing unit couple to the second battery cell, so as to charge the second battery cell with the energy-storage unit.

To sum up, the present invention discloses a charging device and a charging method to improve charge imbalance of charging a plurality of battery cells. During the charging process, if a first battery cell among the battery cells is found to be under an unbalanced state, a current-dividing unit corresponding to the first battery cell will share the total charge current from a charging circuit. Afterward, a partial charge current of the total charge current is used to charge the first battery cell which is relatively over-charged and the total charge current is used to charge the other batter cells which are relatively under-charged. Accordingly, the charge imbalance is compensated. Moreover, if the first battery cell is found to be under an unbalanced fine-tune state, the charging circuit will generate a balance fine-tune current less than the total charge current to further improve the charge imbalance as explained before.

Finally, please note that the aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention.

What is claimed is:

1. A charging device for charging a plurality of battery cells, the plurality of battery cells comprising a first battery cell and a second battery cell, each of the first and second battery cells comprising a first electrode and a second electrode, the second electrode of the first battery cell coupling to the first electrode of the second battery cell such that the first and second battery cells couple to each other in series, the charging device comprising:
a node coupling to the first electrode of the first battery cell;
a charging circuit coupling to the node and providing a first charge current or a second charge current for the node, wherein the first charge current is larger than the second charge current;
a current-dividing unit coupling to the node and having a first impedance under a first state and a second impedance under a second state, wherein the first impedance is higher than the second impedance; and
a control circuit coupling to the charging circuit, the current-dividing unit and the first and second battery cells, controlling the charging circuit to produce the first charge current or the second charge current and controlling the current-dividing unit to be under the first or second state, the control circuit comprising:
a front-end circuit coupling to the first battery cell, the second battery cell and the current-dividing unit and being used to detect the voltages of the first and second battery cells to generate a voltage detection result and make the current-dividing unit enter the second state from the first state; and
a back-end circuit coupling to the front-end circuit and the charging circuit and being used to receive the voltage detection result from the front-end circuit, control the front-end circuit to make the current-dividing unit enter the second state from the first state if the voltage detection result indicates an unbalanced state and control the charging circuit to provide the second charge current instead of the first charge current if the voltage detection result indicates an unbalanced fine-tune state.

2. The charging device of claim 1, wherein the unbalanced state represents that the voltage of the first battery cell is higher than a first preset over-charge value and the voltage difference between the first and second battery cells is higher than a preset balance value.

3. The charging device of claim 2, wherein the unbalanced fine-tune state represents that the voltage of the first battery cell is higher than a second preset over-charge value which is higher than the first preset over-charge value and the voltage difference between the first and second battery cells is higher than the preset balance value.

4. The charging device of claim 1, wherein the current-dividing unit comprises:
a switch component staying under an on state to allow a partial charge current of the first charge current coming in or staying under an off state to block the first charge current based on the control of the front-end circuit; meanwhile, the current-dividing unit is under the first state if the switch component maintains the off state and under the second state if the switch component maintains the on state; and
a resistor bearing the partial charge current of the first charge current when the switch component maintains the on state.

5. The charging device of claim 1, wherein the current-dividing unit comprises an energy-storage unit which stores the energy of a partial charge current of the first charge current when the current-dividing unit is under the second state and charges the second battery cell after the current-dividing unit enters the first state from the second state.

6. The charging device of claim 1, wherein the back-end circuit comprises a setting unit for a user to set the magnitude of the first and/or second charge currents.

7. The charging device of claim 1, wherein the back-end circuit comprises a learning unit which collects a historical data about the usage information of the charging device and sets the magnitude of the first and second charge currents according to the historical data.

8. A charging method for charging a plurality of battery cells, the plurality of battery cells comprising a first battery cell and a second battery cell, each of the first and second battery cells comprising a first electrode and a second electrode, the second electrode of the first battery cell coupling to the first electrode of the second battery cell such that the first and second battery cells couple to each other in series, the first electrode of the first battery cell coupling to a node which couples to a current-dividing unit and a charging circuit, the charging method comprising the steps of:
utilizing the charging circuit to provide a first charge current for the node;
utilizing a control circuit to detect the voltages of the first and second battery cells to generate a voltage detection result;
according to the voltage detection result, utilizing the control circuit to make the current-dividing unit enter a second state from a first state to share the first charge current if the voltage detection result indicates an unbalanced state, wherein the current-dividing unit has a first impedance under the first state and a second impedance which is less than the first impedance under the second state; and
according to the voltage detection result, utilizing the control circuit to make the charging circuit provide a second charge current instead of the first charge current if the voltage detection result indicates an unbalanced fine-tune state and consequently have the current-dividing unit share the second charge current.

9. The charging method of claim 8, wherein the unbalanced state represents that the voltage of the first battery cell is higher than a first preset over-charge value and the voltage difference between the first and second battery cells is higher than a preset balance value.

10. The charging method of claim 9, wherein the unbalanced fine-tune state represents that the voltage of the first battery cell is higher than a second preset over-charge value which is higher than the first preset over-charge value and the voltage difference between the first and second battery cells is higher than the preset balance value.

11. The charging method of claim 8, further comprising the step of utilizing an energy-storage unit to store the energy of a partial charge current of the first charge current when the current-dividing unit is under the second state and charge the second battery cell after the current-dividing unit returns to the first state from the second state.

12. A charging device for charging a plurality of battery cells, the plurality of battery cells comprising a first battery cell and a second battery cell, each of the first and second battery cells comprising a first electrode and a second electrode, the second electrode of the first battery cell coupling to the first electrode of the second battery cell such that the first and second battery cells couple to each other in series, the charging device comprising:
a node coupling to the first electrode of the first battery cell;
a charging circuit coupling to the node and providing a charge current for the node;
a current-dividing unit coupling to the node and functioning as an open circuit to block the charge current under a first state and a resistor with finite resistance to share the charge current under a second state; and
a control circuit coupling to the charging circuit, the current-dividing unit and the first and second battery cells and controlling the current-dividing unit to be under the first or second state,
wherein the current-dividing unit comprises an energy-storage unit which stores the energy of a partial charge current of the first charge current when the current-dividing unit is under the second state and charges the second battery cell after the current-dividing unit returns to the first state from the second state.
